(19) United States
(12) Patent Application Publication
(10) Pub. No.: US 2005/0031082 A1
(43) Pub. Date: Feb. 10, 2005

(54) X-ray dose control based on patient size

(76) Inventors: John R. Haaga, Chagrin Falls, OH (US); Jeffrey L. Duerk, Avon Lake, OH (US)

Correspondence Address: Diane H Dobrea;Calfee Halter & Griswold, 800 Superior Avenue, Suite 1400, Cleveland, OH, 44114, US

(21) Appl. No.: 10/485,056

(22) PCT Filed: Jul. 24, 2002
(86) PCT No.: PCT/US02/23687

Related U.S. Application Data
(60) Provisional application No. 60/307,429, filed on Jul. 24, 2001.

(51) Int. Cl. H05G 1/44

(52) U.S. Cl. 378/108

(57) ABSTRACT

Automatic x-ray dosage control based on patient size is described. The system provides a computer-based system for determining patient size based on mathematical analysis of light employed to illuminate a patient and light detectors. The system also provides a computer based system for calculating an x-ray dose parameter based on the determined patient size.

### CROSS REFERENCE TO RELATED APPLICATIONS

This application claims the benefit of U.S. Provisional Application 60/307,429 titled “X-Ray Dose Control Based on Patient Size”, filed Jul. 24, 2001, which is incorporated herein by reference.

### TECHNICAL FIELD

The methods, systems, and computer readable media described herein relate generally to x-ray technology and more particularly to improving medical care by tailoring x-ray dosage to body size.

### BACKGROUND

X-ray computed tomography utilizes a rotating x-ray source and x-ray detectors to generate cross-sectional images. When used in human applications, it is desired to minimize exposure to x-ray radiation while at the same time maximizing the diagnostic quality of the generated images. In order to achieve an acceptable balance of these competing goals, methods are needed to reduce or appropriately adjust radiation dosage in order to better control radiation exposure. Commonly, peak kilovoltage (kV) and tube current (mA) are set based on technologist or physician perception of patient weight, sex, age, and body part to be imaged. However, when the patient deviates significantly from an anticipated size (larger or smaller) or if conventional paradigms are used blindly, unnecessary overexposure (excessive dose) or underexposure (insufficient image quality for favorable risk-benefit) may result.

Other methods for reducing radiation dosage with spiral CT scanning technology has involved increasing the pitch of the examination. It has been shown that increasing pitch from 1.0 to 1.5 decreased the radiation dosage by 33% without an apparent loss of diagnostic information. However, none of the known methods use body size or dimensions to estimate the desired dosage, which is believed a better approximation of tissue length traversed during scanning because body weight alone does not account for variations in body size or dimensions.

### SUMMARY

This application concerns automated systems and methods that control x-ray exposure based on an actual patient size rather than on statistical considerations of average patient weight or other commonly accepted paradigms used to control imaging exposure to x-ray radiation.

The following presents a simplified summary of methods, systems, and computer readable media for automatically controlling x-ray dosage to facilitate providing a basic understanding of these items. This summary is not an extensive overview and is not intended to identify key or critical elements of the methods, systems, and computer readable media or to delineate the scope of these items. This summary provides a conceptual introduction in a simplified form as a prelude to the more detailed description that is presented later.

This application describes methods and systems for automating x-ray exposure control. Examples that perform dose estimation are provided. In one example, a light source is used to illuminate a patient (e.g., human, animal) in cross sections. Opposite the patient are a set of detectors that detect approximate patient dimensions to be imaged based on which detectors sense light and/or the intensity of that light. A number of possible geometric arrangements of the source/detector pair are possible. From the emitted and/or detected signal information, patient dimensions, (e.g., height, width, area, volume) are computed. From these, the x-ray dose (kV and mA) can be set to a level that is appropriate for these dimensions in order to maintain image quality while not exposing the patient to unnecessary radiation.

In one example, patient anatomy dimensions are determined with the x-ray radiation source and detector provided by a computed tomography (CT) system. For example, the topogram that is conventionally acquired for image slice acquisition determination is used. This topogram provides a direct measure of the x-ray attenuation in cross section of the patient. As such, information from the topogram at each slice is used to determine the dimensions of the area to be imaged and the radiation dose, (e.g., kV, mA), is adjusted based on those dimensions. Thus, this information facilitates adjusting the acquisition parameters for cross sectional images.

Certain illustrative example methods, systems, and computer readable media are described herein in connection with the following description and the annexed drawings. These examples are indicative, however, of but a few of the various ways in which the principles of the methods, systems, and computer readable media may be employed and thus are intended to be inclusive of equivalents. Other advantages and novel features may become apparent from the following detailed description when considered in conjunction with the drawings.

### BRIEF DESCRIPTION OF THE DRAWINGS

FIG. 1 illustrates measuring a patient dimension using an existing x-ray source detector from a CT scanner.

FIG. 2 illustrates an example system for measuring one dimension of a patient using a single light source and a first set of light detectors.

FIG. 3 illustrates an example system for measuring a second dimension of the patient from FIG. 2 using a single light source and a second set of light detectors.

FIG. 4 illustrates an example system for measuring a dimension of a patient using set of light sources and a set of light detectors.

FIG. 5 illustrates an example system for measuring a dimension of a patient using movable light source and a set of light detectors.

FIG. 6 is a schematic block diagram of an example system for computing an x-ray dosage.

FIG. 7 is a schematic block diagram of an example system for computing an x-ray dosage.

FIG. 8 is a flow chart of an example method for computing an x-ray dosage.

FIG. 9 is a flow chart of an example method for computing an x-ray dosage.

FIG. 10 is a schematic block diagram of an example computer on which compute executable portions of the systems and methods described herein can reside and/or be performed.

### DETAILED DESCRIPTION

Example methods, systems, and computer readable media are now described with reference to the drawings, where like reference numerals are used to refer to like element throughout. In the following description, for purposes of explanation, numerous specific details are set forth in order to facilitate thoroughly understanding the methods, systems and computer readable media. It may be evident, however, that the methods, systems and computer readable media can be practiced without these specific details. In other instances well-known structures and devices are shown in block diagram form in order to simplify description.

As used in this application, the term “computer component” refers to a computer related entity, either hardware, firmware, software, a combination thereof, or software i execution. For example, a computer component can be, but is not limited to being, a process running on a processor, a processor, an object, an executable, a thread of execution, program, and a computer. By way of illustration, both an application running on a server and the server can be computer components. One or more computer components can reside within a process and/or thread of execution and a computer component can be localized on one computer and/or distributed between two or more computers.

“Logic”, as used herein, includes but is not limited to hardware, firmware, software and/or combinations of each to perform a function(s) or an action(s). For example, based on a desired application or needs, logic may include a software controlled microprocessor, discrete logic such as an application specific integrated circuit (ASIC), or other programmed logic device. Logic may also be fully embodied as software.

“Signal”, as used herein, includes but is not limited to one or more electrical or optical signals, analog or digital, one or more computer instructions, a bit or bit stream, or the like.

“Software”, as used herein, includes but is not limited to, one or more computer readable and/or executable instructions that cause a computer or other electronic device to perform functions, actions and/or behave in a desired manner. The instructions may be embodied in various forms like routines, algorithms, modules, methods, threads, and/or programs. Software may also be implemented in a variety of executable and/or loadable forms including, but not limited to, a stand-alone program, a function call (local and/or remote), a servelet, an applet, instructions stored in a memory, part of an operating system or browser, and the like. It is to be appreciated that the computer readable and/or executable instructions can be located in one computer component and/or distributed between two or more communicating, co-operating, and/or parallel processing computer components and thus can be loaded and/or executed in serial, parallel, massively parallel and other manners.

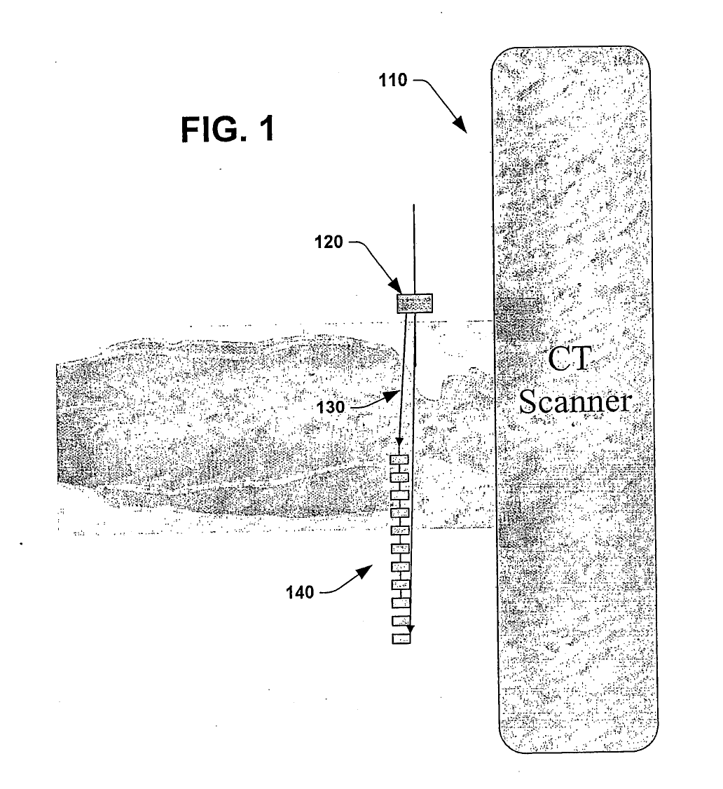

FIG. 1 illustrates measuring a patient dimension using existing x-ray source detectors from a CT scanner 110. As noted above, current x-ray computed tomographic systems manually adjust x-ray parameters (e.g., kV, mA) based on the experience of a technologist, the impressions of a physician, and otherwise heuristic paradigms. The patient size is not explicitly or routinely included in the adjustment of these parameters. Thus, the patient either receives more dose than necessary to achieve diagnostically acceptable images (small patient-conventional paradigms) or insufficient exposure (large patient-conventional paradigms). Thus, the risk-benefit trade-off of exposure to image quality is typically not adjusted for each patient.

In FIG. 1, existing X-ray source/detector pairs present in the CT scanner 110 system are employed in a very low energy configuration. For example, an x-ray source 120 can generate a low energy x-ray beam 130 that is detected by one or more x-ray detectors 140. While eleven x-ray detectors 140 are illustrated, it is to be appreciated that a greater and/or lesser number of such elements can be employed with the systems and methods described herein. Similarly, while a single x-ray source 120 is illustrated it is to be appreciated that a greater number of such elements can be employed with the systems and methods described herein. Parameters like the width, height, area, and volume of a patient area are determined from exposures at two or more orientations. The orientations can be, for example, 90 degrees relative to each other. While the orientations can be 90 degrees relative to each other, it is to be appreciated that other orientations can be employed with the systems and methods described herein. Detector exposure and geometric relationships facilitate determining the patient dimensions. When the dimensions are obtained, the imaging x-ray dose is adjusted accordingly. Using x-rays to acquire patient size is less desirable from a “risk/benefit” or medical perspective than using light beams since x-ray exposure has to be accomplished to obtain the information employed in adjusting x-ray dosage. However, it is desirable from a manufacturing and/or production perspective since existing detectors can be used without requiring additional detectors/light sources.

The information from the detectors 140 can be sent to a processor (not illustrated), like a computer and/or computer component, that executes software that interprets the detector information and determines patient dimensions based on the exposure levels detected by the detectors. The patient dimensions are then computed as well as image area, and the kV and mA settings are automatically adjusted based on the patient dimensions. With the automatic adjustment, the system generates appropriate diagnostic images using an appropriate dose of radiation based on the amount of tissue being imaged. In other words, the system maintains the quality of the images generated while minimizing the amount of radiation exposure to a patient. The kV and mA settings can be increased or decreased from a default setting in equal amounts or in non-equal amounts based on predetermined measurements of appropriate exposure required for a given area to be imaged.

In one example, patient dimensions can be compared to default average dimensions, and ratios determined from the current patient dimensions to the default dimensions are calculated. Then, the kV and mA settings are adjusted from a default setting that is appropriate for the default patient dimensions in accordance with the ratios. One example system can include data tables of patient sizes and radiation settings and a mapping function that maps an inputted patient size to an optimal radiation dose that will maintain a good image quality with a minimum x-ray exposure. If only one dimension is measured for a patient, other dimensions can be obtained by interpolation.

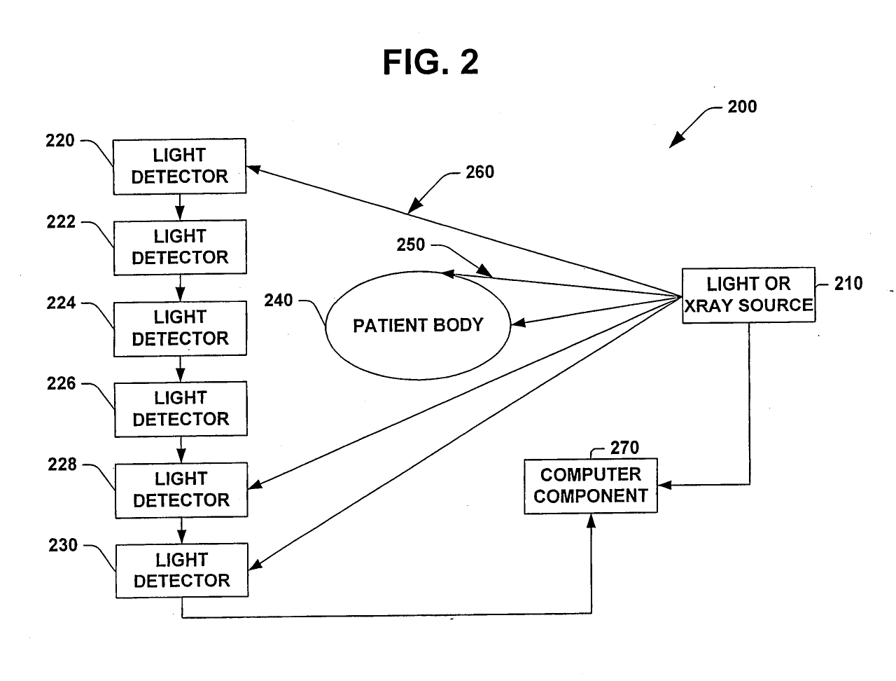

FIG. 2 illustrates one example system 200 for measuring one dimension of a patient body 240 using a single light source 210 and a first set of light detectors (e.g., detectors 220 and 222 through 230). The light source 210 generates light beams (e.g., 250, 260), some of which intersect with a patient body 240 (e.g., beam 250), while some others are detected at a light detector (e.g., beam 260). A computer component 270 collects information associated with the generated and/or detected beams. The computer component 270 then calculates one or more patient dimensions (e.g., height, width, area, volume), based, at least in part, on the generated and/or detected beams. From the patient dimension(s), x-ray dosage (e.g., mA, kV) can be determined, which facilitates controlling x-ray dosage based on patient size.

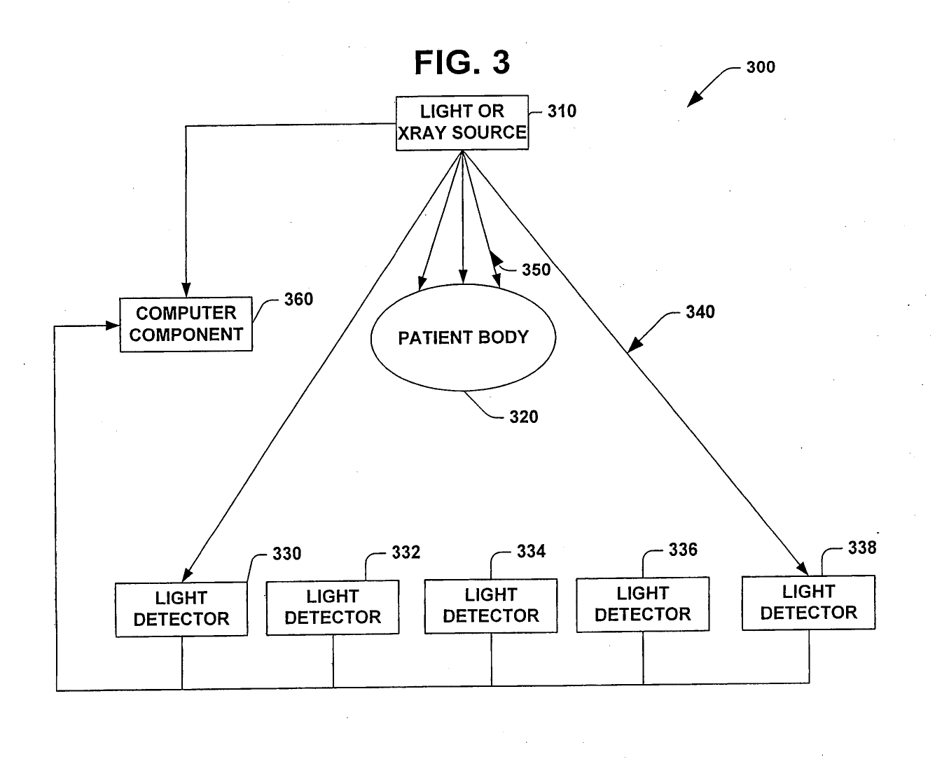

In one example, dimensions, (e.g., width, height, area, volume) of patient tissue to be imaged are measured automatically. In system 200, a first set of light detectors, (oriented perpendicular to a second set of light detectors illustrated in FIG. 3) and an opposing light source 210 is employed to produce a first illumination of a patient body 240 from a first projection angle. The light source 210 can be aligned to ensure that transmission of light beams spans the patient body 240 and intersects with the detectors. Prior to x-ray imaging, the first light source 210 is activated, and dimension data associated with the patient body 240 is determined. Subsequently, a second light source is employed to illuminate the patient body 240 from a different projection angle, employing a second set of detectors to detect the light. Based, for example, on the number and/or location of detectors illuminated, and/or the intensity of the illumination at the detectors, the dimension(s) of the patient is determined. Solving trigonometric relationships with data extracted from the illuminations facilitates calculating the patient dimensions.

There are many possible configurations of detector/source pair(s). For example, there could be one source and one detector that rotate through 90 degrees to obtain two pieces of information, (e.g. height, width). In one example, the pair can be rotated to substantially any degree between 0 and 360 to obtain a desired measurement from partial to full dimensions. Additionally, and/or alternatively, there could be multiple detectors and one source (e.g., laser) that moves from below to above the patient (or from left to right). Furthermore, the source could be fixed in space, but made to oscillate during transmission so that the “beam” sweeps across the patient.

A light source and detector configuration can be separate from the gantry of a diagnostic machine or can be included as part of the gantry. For an existing diagnostic machine, the gantry can be modified or retrofitted with the light source, detectors and/or computer components. The light source may be an illumination device like an incandescent light, laser, or the like. The detectors include photodiodes, photoresistors, or other light detecting cells or devices. Filters may also be associated with the detectors based on the light source used to facilitate receiving light from specified light sources. Similarly, filters may be associated with the light sources to facilitate selectively illuminating detectors. To determine a patient dimension, one example system determines which photodetectors detected light and which did not (e.g. on or off). Those that did not detect light are covered by the patient and thus that area of detectors is related to the area of the patient in cross section. While a single linear row of detectors is illustrated, it is to be appreciated that other two and/or three dimensional configurations of detectors and/or light sources can be employed with the systems and methods described herein.

It will be appreciated by one of ordinary skill in the art, that the present invention is applicable to medical diagnostic machines like x-ray, CT, SPECT, MRI and other nuclear diagnostic machines as known in the art.

FIG. 3 illustrates an example system 300 for measuring a second dimension of a patient body 320 (e.g. patient body 240, FIG. 2) using a single light source 310 and a second set of light detectors (e.g., detectors 330 and 332 through 338). While five light detectors are illustrated, it is to be appreciated that a greater and/or lesser number of such elements can be employed with the systems and methods described herein. Furthermore, while in FIG. 3 the light source 310 is positioned at a second position relative to the patient body 320 and in FIG. 2 the light source 210 was positioned at a first position relative to the patient body 210, it is to be appreciated that the light source 310 and the light source 210 can be the same light source that can be moved from position to position. Similarly, light source 310 and light source 210 could be separate light sources that can be fixed relative to each other, or moveable relative to each other. Furthermore, two or more fixed or moveable light sources could be employed with the systems and methods described herein.

In FIG. 3, the light source 310 generates light beams. Some of the light beams (e.g., 350) intersect the patient body 320 and thus are not detected at the light detectors. Other light beams (e.g., 340) do not intersect the patient body 320 and thus are detected by one or more light detectors (e.g., detector 338). By determining what light beams were emitted and/or what light beams were detected, a computer component 360 can calculate a patient dimension (e.g., height, width, area, volume). Acquiring multiple sets of light beams that were projected from various angles facilitates calculating the dimensions of irregular shaped items (e.g., a bent elbow, a bent knee) and more regular shaped items (e.g. substantially cylindrical abdomen). Thus, the light source 310 may generate a plurality of sets of light beams that intersect the patient body 320 and/or are detected by the light detectors. Mathematical techniques (e.g., trigonometry, calculus, analytical geometry of solid bodies) can be employed to calculate the dimensions of the patient body 320 using data extracted from the emitted and/or detected light beams.

In one example, the source 310 emits low energy x-rays that are detected at detectors. Thus, some x-rays will pass directly to the detectors without transiting the patient body 320, some will transit the patient body 320 and arrive in an attenuated form at the detector(s), and yet others will be absorbed by the patient body 320. In this example, the computer component 360 can analyze beam attenuation and similarly employ well known mathematical techniques to calculate patient dimensions.

Once the patient dimensions are determined, an appropriate x-ray dosage is calculated, providing advantages over conventional systems that do not automatically calculate patient size.

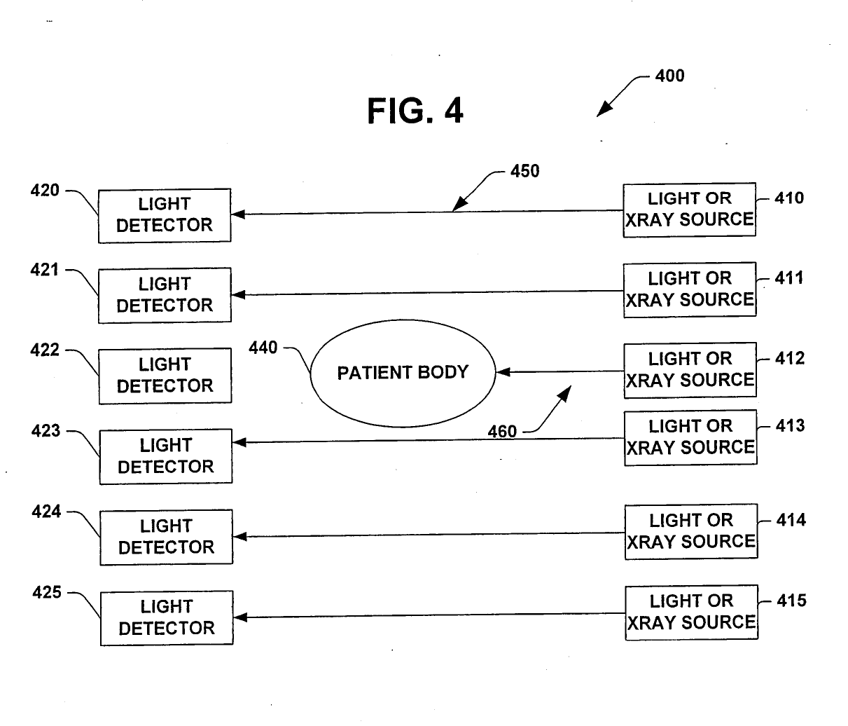

FIG. 4 illustrates one example system 400 for measuring a dimension of a patient body 440 using a set of light sources and a set of light detectors. The set of light sources includes sources 410 and 411 through 415. Similarly, the set of light detectors includes detectors 420 and 421 through 425. While six sources and six detectors are illustrated, it is to be appreciated that a greater and/or lesser number of sources and/or detectors can be employed with the systems and methods described herein.

In FIG. 4, a light source (e.g., 410) can generate a light beam (e.g., 450) that is detected at a light detector (e.g., 420). In one example, filters and/or lenses are employed to direct and/or focus the light beam 450 so that it is received at the desired light detector. Similarly, special light (e.g. polarized, laser) can be employed to facilitate directing light from a specified source to a specified destination. Some beams (e.g., 460) will be prevented from traveling to a detector by the patient body 440. By correlating data concerning which beams were emitted and which beams were detected, dimensions (e.g. height, width, area, volume) of the patient body 440 can be detected.

In one example, the set of light sources and the set of light detectors can be programmatically moved relative to the patient body 440. Thus, for example, the set of light sources and detectors could be rotated about the patient body 440 to facilitate retrieving multiple views of the patient body from multiple projection angles. Thus, sophisticated mathematical techniques (e.g., analytical geometry of solid bodies, calculus) can be employed to more accurately compute the patient body 440 dimensions. Based on these computations, a more accurate x-ray dosage can be computed. For example, on a first dimension (e.g. along an x axis) the patient body 440 may require a first x-ray dosage to achieve a diagnostic quality image while on a second dimension (e.g. along a y axis) the patient body may require a second x-ray dosage to achieve a diagnostic quality image. By way of illustration, more dosage may be required to image the hips from left to right through the hip sockets while less dosage is required to image the hips from directly above the navel. Conventionally, the patient may receive a higher, average dosage to ensure that diagnostic quality images are acquired along desired dimensions. However, by measuring, substantially in real-time, the dimensions of the patient body 440, on a per projection angle basis, a lower dosage may be computed, reducing health risks to the patient.

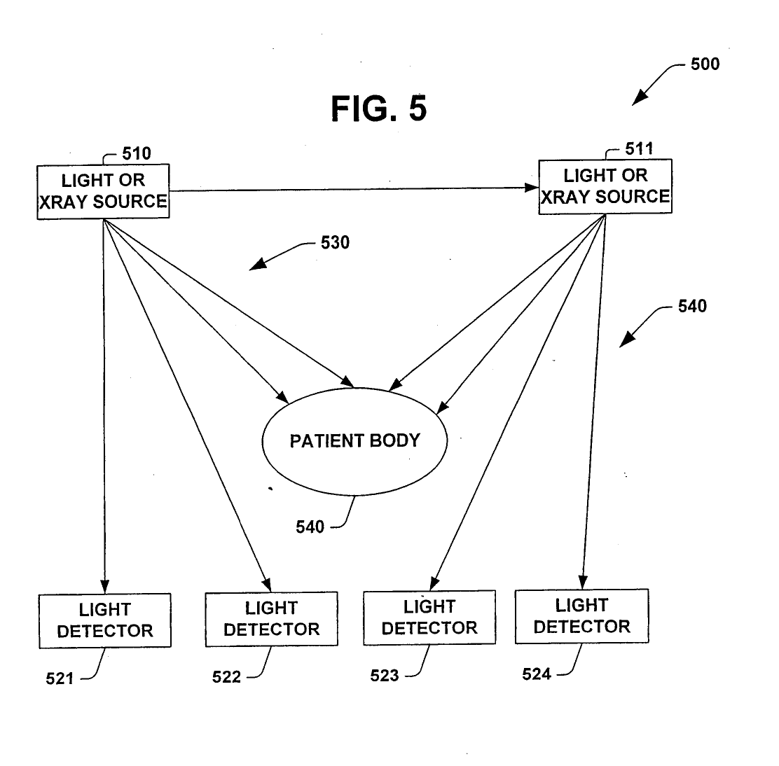

FIG. 5 illustrates an example system 500 for measuring a dimension of a patient body 540 using a movable light source and a set of light detectors. The light source may first be positioned at a position 510. While at this first position 510, a first set of light beams (e.g., set 530) may be generated, which can be analyzed using the techniques described herein. From the first set of beams 530, a subset of the beams may be detected at the detectors. Then, the light source may be moved to another position (e.g., 511) where a second set of light beams (e.g. set 540) may be generated, which can also be analyzed using techniques described herein. From the second set of beams 540, a second subset of beams may be detected. The subset of light beams may be detected, for example, by a set of light detectors (e.g. detectors 521 and 522 through 524). While two positions and four detectors are illustrated, it is to be appreciated that a greater and/or lesser number of positions and/or detectors can be employed with the present invention.

By selectively positioning the light source at various positions, generating sets of light beams and detecting the beams, dimensions of the patient body 540 can be determined. From these dimensions, x-ray dosages can be calculated, facilitating controlling x-ray dosage based on patient size.

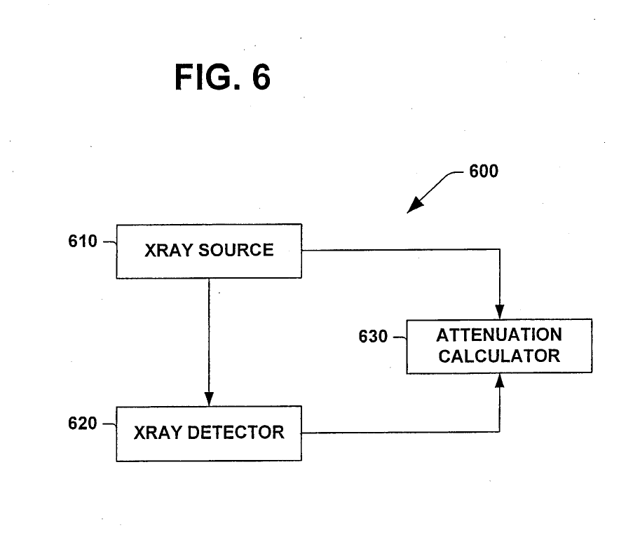

FIG. 6 is a schematic block diagram of an example system 600 for computing an x-ray dosage. The system 600 includes an x-ray source 610 that generates x-rays. The x-rays are detected by an x-ray detector 620. Information associated with the generated x-rays and the detected x-rays is gathered and analyzed by an attenuation calculator 630 to facilitate determining how, if at all, the generated x-rays were attenuated. Based on the attenuation of the x-rays, one or more dimensions (e.g. height, width, area, volume, density) of an object through which the x-rays passed can be calculated. Also, beams that passed through no object can also be analyzed to facilitate determining dimensions. From these dimensions, x-ray dosages for imaging an object can be determined, which facilitates controlling x-ray dosage based on patient size. While one x-ray source 610, x-ray detector 620, and attenuation calculator 630 are illustrated, it is to be appreciated that more than one source, detector and or calculator can be employed with the systems and methods described herein. In one example, the attenuation calculator 630 is a computer component.

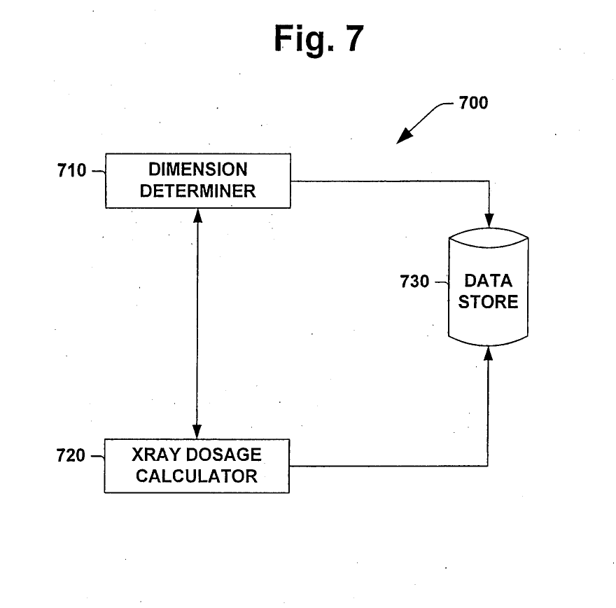

FIG. 7 is a schematic block diagram of an example system 700 for computing an x-ray dosage based on a patient dimension. The system 700 includes a dimension determiner 710 which can be, for example, one of the systems described above (e.g. light sources and detectors, x-ray sources and detectors, associated computers). The system 700 also includes a data store 730, in which information like patient dimensions, x-ray dosages and relationships between patient dimensions and x-ray dosages are stored. The data store 730 can be, for example, a computer component, a data base, a file, and so on. The data store 730 can be located on a single physical and/or logical device and/or distributed between communicating, co-operating devices.

The system 700 also includes an x-ray dosage calculator 720 that interacts with the dimension determiner 710 and/or data store 730 to facilitate retrieving and/or calculating an x-ray dosage for a patient based, at least in part, on the dimensions of the patient as determined by the dimension determiner 710. In one example, after a diagnostic image is generated, a practitioner (e.g. radiologist) may update one or more values and/or relationships in the data store 730 to facilitate improving future images based on dosages calculated from data and/or relationships stored in the data store 730.

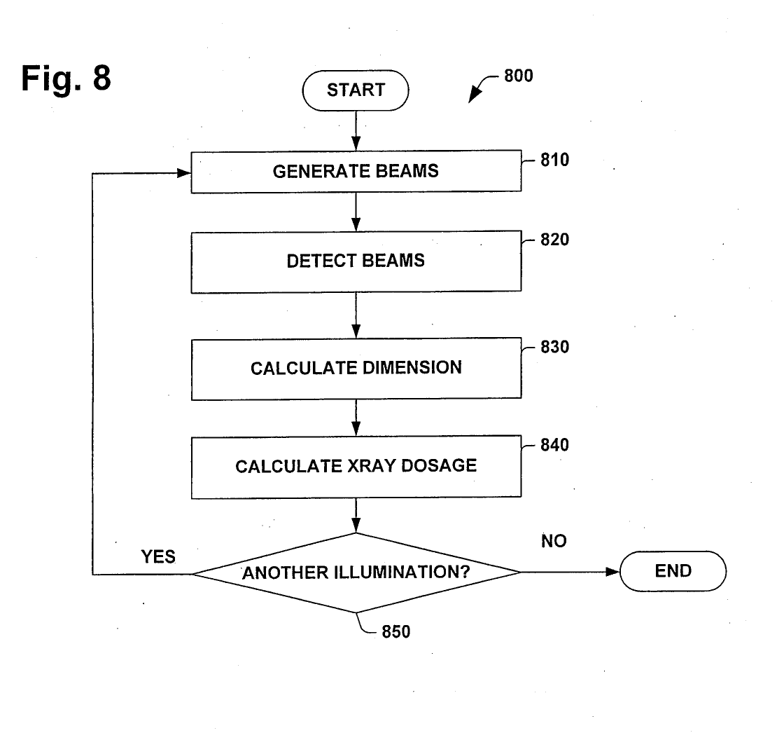

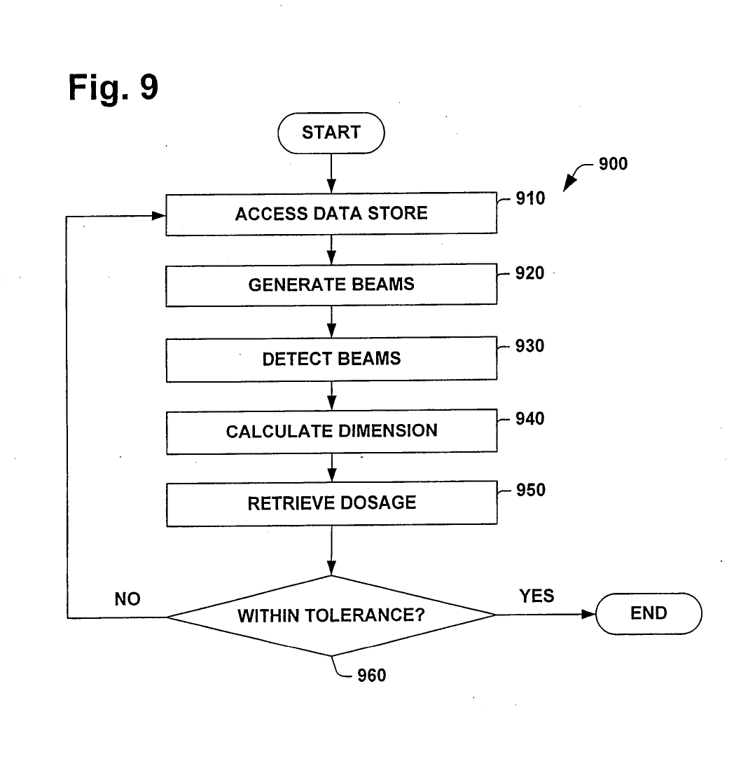

In view of the exemplary systems shown and described herein, example methodologies that are implemented will be better appreciated with reference to the flow diagrams of FIGS. 8 and 9. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks. In one example, methodologies are implemented as computer executable instructions and/or operations, stored on computer readable media including, but not limited to an application specific integrated circuit (ASIC), a compact disc (CD), a digital versatile disk (DVD), a random access memory (RAM), a read only memory (ROM), a programmable read only memory (PROM), an electronically erasable programmable read only memory (EEPROM), a disk, a carrier wave, and a memory stick.

In the flow diagrams, rectangular blocks denote “processing blocks” that may be implemented, for example, in software. Similarly, the diamond shaped blocks denote “decision blocks” or “flow control blocks” that may also be implemented, for example, in software. Alternatively, and/or additionally, the processing and decision blocks can be implemented in functionally equivalent circuits like a digital signal processor (DSP), an application specific integrated circuit (ASIC), and the like.

A flow diagram does not depict syntax for any particular programming language, methodology, or style (e.g., procedural, object-oriented). Rather, a flow diagram illustrates functional information one skilled in the art may employ to program software, design circuits, and so on. It is to be appreciated that in some examples, program elements like temporary variables, routine loops, and so on are not shown.

FIG. 8 is a flow chart of an example method 800 for computing an x-ray dosage based on a patient size. At 810, one or more beams are generated. The beams may be generated, for example, at a beam source. The beam source may be, for example a light source and/or an x-ray source. The beams may be directed at beam detectors to facilitate determining which beams intersected an object interposed between the beam source and the beam detectors.

At 820, beams are detected at the beam detectors. From the generated and detected beams at 830, a dimension of the object can be determined. For example, the width of an object can be calculated by detecting which beams, if any were and were not intersected by an object interposed between the beam source and the beam detectors.

At 840, based on the dimension(s) calculated at 830, an x-ray dosage can be determined. The beams can be generated, detected, and analyzed substantially in real-time and substantially in parallel with diagnostic imaging. Thus, the dimensions can be calculated substantially in real-time and substantially in parallel with diagnostic imaging which facilitates real-time adjustment of x-ray dosage based on patient dimensions. Thus, more appropriate x-ray dosages can be automatically calculated than is possible conventionally.

At 850, a determination is made concerning whether another illumination is desired. If the determination at 850 is YES, then processing returns to 810, otherwise processing can conclude.

FIG. 9 is a flow chart of an example method 900 for computing an x-ray dosage. At 910, a data store is accessed. The data store may store, for example, data associated with patient dimensions, x-ray dosages, and relations between such data. For example, for a first dimension, a first x-ray dosage may be appropriate while for a second dimension a second x-ray dosage may be appropriate. Such relations can be stored, for example, in database logic, database tables, relationships, objects, functions, lookup tables, mapping tables, and so on.

At 920, beams are generated and at 930 the beams are detected. At 940, a patient dimension is calculated using techniques described herein (e.g., trigonometry).

At 950, based on the dimension calculated at 940, the method 900 can retrieve an x-ray dosage from the data store accessed at 910. For example, a database query into a dosage table can be made using the dimension(s) as an index into the table. At 960, a determination is made concerning whether the x-ray dosage is within a tolerance desired by a practitioner and/or automated oversight computer component, for example. By way of illustration, a dosage retrieved at 950 based on the dimension calculated at 940 may be examined by a radiologist to insure that an appropriate dosage has been retrieved. In this way, checks and balances can be implemented to prevent inappropriate exposure to x-ray and the data store 910 can be improved through experience.

While the block at 960 is illustrated in method 900, it is to be appreciated that after appropriate confidence has been developed in the data store, that 960 may be removed from example methods and/or that 960 may not appear in other example methods.

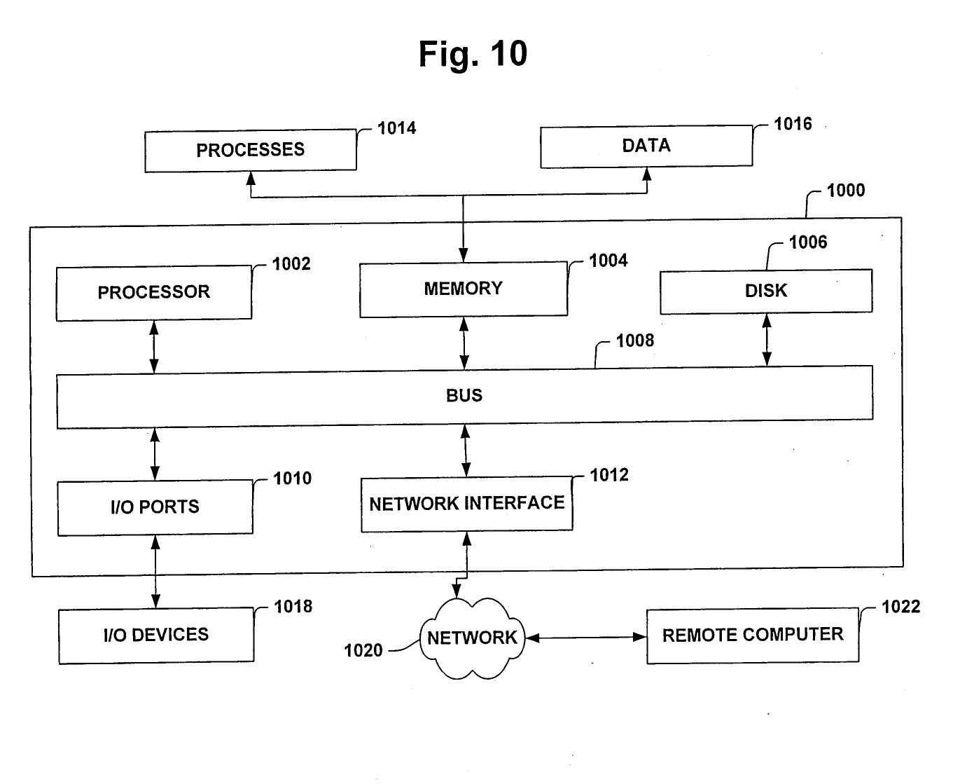

FIG. 10 illustrates a computer 1000 that includes a processor 1002, a memory 1004, a disk 1006, input/output ports 1010, and a network interface 1012 operably connected by a bus 1008. Executable components of the systems described herein may be located on a computer like computer 1000. Similarly, computer executable methods described herein may be performed on a computer like computer 1000. It is to be appreciated that other computers may also be employed with the systems and methods described herein. The computer 1000 may be incorporated into an x-ray device and/or may be separate from the x-ray device, engaging in data communications therewith.

The processor 1002 can be a variety of various processors including dual microprocessor and other multi-processor architectures. The memory 1004 can include volatile memory and/or non-volatile memory. The non-volatile memory can include, but is not limited to, read only memory (ROM), programmable read only memory (PROM), electrically programmable read only memory (EPROM), electrically erasable programmable read only memory (EEPROM), and the like. Volatile memory can include, for example, random access memory (RAM), synchronous RAM (SRAM), dynamic RAM (DRAM), synchronous DRAM (SDRAM), double data rate SDRAM (DDR SDRAM), and direct RAM bus RAM (DRRAM). The disk 1006 can include, but is not limited to, devices like a magnetic disk drive, a floppy disk drive, a tape drive, a Zip drive, a flash memory card, and/or a memory stick. Furthermore, the disk 1006 can include optical drives like, compact disk ROM (CD-ROM), a CD recordable drive (CD-R drive), a CD rewriteable drive (CD-RW drive) and/or a digital versatile ROM drive (DVD ROM). The memory 1004 can store processes 1014 and/or data 1016, for example. The disk 1006 and/or memory 1004 can store an operating system that controls and allocates resources of the computer 1000.

The bus 1008 can be a single internal bus interconnect architecture and/or other bus architectures. The bus 1008 can be of a variety of types including, but not limited to, a memory bus or memory controller, a peripheral bus or external bus, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 1000 interacts with input/output devices 1018 via input/output ports 1010. Input/output devices 1018 can include, but are not limited to, a keyboard, a microphone, a pointing and selection device, cameras, video cards, displays, and the like. The input/output ports 1010 can include but are not limited to, serial ports, parallel ports, and USB ports.

The computer 1000 can operate in a network environment and thus is connected to a network 1020 by a network interface 1012. Through the network 1020, the computer 1000 may be logically connected to a remote computer 1022. The network 1020 includes, but is not limited to, local area networks (LAN), wide area networks (WAN), and other networks. The network interface 1012 can connect to local area network technologies including, but not limited to, fiber distributed data interface (FDDI), copper distributed data interface (CDDI), ethernet/IEEE 802.3, token ring/IEEE 802.5, and the like. Similarly, the network interface 1012 can connect to wide area network technologies including, but not limited to, point to point links, and circuit switching networks like integrated services digital networks (ISDN), packet switching networks, and digital subscriber lines (DSL).

Computer executable aspects of the systems and methods described herein may be stored, for example, on a computer readable media. Media can include, but are not limited to, an application specific integrated circuit (ASIC), a compact disc (CD), a digital versatile disk (DVD), a random access memory (RAM), a read only memory (ROM), a programmable read only memory (PROM), a disk, a carrier wave, a memory stick, and the like. Thus, an example computer readable medium can store computer executable instructions for a method for calculating an x-ray dose. The method can include, at a beam source, generating beams directed at beam detectors, where an object is interposed between the beam source and the beam detectors. The method also includes detecting beams at the beam detectors, calculating a dimension of the object based, at least in part, on the beams, and determining an x-ray dose based, at least in part, on the dimension. The x-ray dose may be varied, for example, in mA and/or kV.

What has been described above includes several examples. It is, of course, not possible to describe every conceivable combination of components or methodologies for purposes of describing the methods, systems, computer readable media and so on employed in automatically controlling x-ray dosage. However, one of ordinary skill in the art may recognize that further combinations and permutations are possible. Accordingly, this application is intended to embrace alterations, modifications, and variations that fall within the scope of the appended claims. Furthermore, to the extent that the term “includes” is employed in the detailed description or the claims, it is intended to be inclusive in a manner similar to the term “comprising” as that term is interpreted when employed as a transitional word in a claim.

1. A system for determining one or more x-ray parameters, comprising:
computing a computed size of a patient to be x-rayed; and
determining the one or more x-ray parameters based, at least in part, on the computed size of the patient.

2. The system of claim 1, where the one or more x-ray parameters comprise kV and mA.

3. The system of claim 1, where the computed size of the patient is determined as one or more cross sectional areas.

4. An x-ray system, comprising:
an x-ray radiation source for emitting an emitted x-ray;
an x-ray detector for detecting a detected x-ray;
a computer component for determining an x-ray attenuation based on a comparison of the emitted x-ray and the detected x-ray.

5. The system of claim 4, where the computer component determines an x-ray dose based, at least in part, on the x-ray attenuation.

6. The system of claim 4, comprising a second computer component that determines an x-ray dose based, at least in part, on the x-ray attenuation.

7. The system of claim 4, where the computer component collects two or more detected x-rays, where the two or more detected x-rays were emitted in directions perpendicular to each other.

8. A system for automatically controlling x-ray exposure, comprising:
one or more light detectors;
one or more light sources for illuminating a patient and a subset of the one or more light detectors with one or more light beams;
a computer component for computing a patient dimensional data from one or more detected light beams and for determining one or more patient size parameters based, at least in part, on the patient dimensional data; and
a computer component for determining an x-ray dose parameter based, at least in part, on the patient dimensional data.

9. The system of claim 8, where the patient dimensional data is one of a patient height, width, area, and volume.

10. The system of claim 8, where the x-ray dose parameter is one of kV and mA.

11. A system for computing an x-ray dose parameter, comprising:
a first light source for emitting a first set of light beams that produce a first illumination of a patient from a first projection angle;
a first set of light detectors for receiving a subset of the first set of light beams, where the subset of the first set of light beams comprises light beams that travel from the first light source to one or more of the first set of light detectors without being blocked by the patient;
a second light source for emitting a second set of light beams that produce a second illumination of a patient from a second projection angle;
a second set of light detectors for receiving a subset of the second set of light beams, where the subset of the second set of light beams comprises light beams that travel from the second light source to one or more of the second set of light detectors without being blocked by the patient; and
a computer component that determines a patient dimension based, at least in part, on analyzing one or more of, the emitted first set of light beams, the received subset of the first set of light beams, the emitted second set of light beams, and the received subset of the second set of light beams.

12. The system of claim 11, where the first set of light detectors and the second set of light detectors are arranged perpendicular to each other.

13. The system of claim 11, where one or more of the first light source, the second light source, the first set of light detectors, and the second set of light detectors are moveable relative to each other to facilitate acquiring subsets of light beams oriented at a plurality of angles relative to each other.

14. The system of claim 13, where one or more of the first light source, the second light source, the first set of light detectors, and the second set of light detectors are moveable under programmatic control.

15. The system of claim 11, where the patient dimension is one or more of, a patient height, width, area, and volume.

16. The system of claim 15, comprising a computer component for determining an x-ray dose based, at least in part, on the patient dimension.

17. The system of claim 11, where the patient dimension is calculated by solving one or more trigonometric relations from data acquired during one or more of, the first illumination and the second illumination.

18. A system for computing an x-ray dose parameter, comprising:
a light source for emitting a set of light beams to produce an illumination of a patient from a projection angle;
a set of light detectors for receiving a subset of the set of light beams, where the subset comprises light beams that travel from the light source to one or more of the set of light detectors without being blocked by the patient; and
a computer component that determines a patient dimension based, at least in part, on analyzing the emitted set of light beams and the received subset of the set of light beams.

19. The system of claim 18, where the light source is moveable, under programmatic control, relative to the set of light detectors, to facilitate illuminating a patient from a plurality of projection angles.

20. The system of claim 19, where the patient dimension is calculated by solving one or more trigonometric relations from data associated with illuminations of the patient from a plurality of projection angles.

21. An x-ray system, comprising:
a data store that stores one or more patient dimensions and one or more related x-ray dosages;
a patient dimension determiner that determines an actual patient dimension; and
an x-ray dosage selector that selects an x-ray dosage from the data store based, at least in part, on the actual patient dimension.

22. The system of claim 21, where the patient dimension determiner comprises:
one or more light detectors;
one or more light sources for directing light onto a patient interposed between the one or more light sources and the one or more light detectors; and
a computer component for calculating the actual patient dimension based, at least in part, on a light received at the one or more light detectors.

23. A method for calculating an x-ray dose, comprising:
at a beam source, generating one or more beams directed at one or more beam detectors, where an object is interposed between the beam source and the beam detectors;
detecting one or more detected beams at the one or more beam detectors;
calculating a dimension of the object based, at least in part, on the one or more detected beams; and
determining an x-ray dose based, at least in part, on the dimension.

24. The method of claim 23, where the object is a patient.

25. The method of claim 23, where the beams are one or more of a light beam and an x-ray beam.

26. The method of claim 23, where the dimension is one of height, width, area, and volume.

27. The method of claim 23, where the dimension is calculated by solving one or more trigonometric relations with data derived from the one or more detected beams.

28. The method of claim 23, where the x-ray dose comprises one or more of mA and kV.

29. A computer readable medium storing computer executable instructions operable to perform computer executable elements of the method of claim 23.

30. A method for controlling an x-ray dose based on a patient size, comprising:
accessing a data store wherein one or more patient sizes and one or more related x-ray dosages are stored;
generating one or more beams to illuminate a patient and one or more beam detectors;
detecting one or more beams;
calculating a patient size based, at least in part, on one or more of the one or more generated beams and the one or more detected beams;
retrieving a dosage from the data store based, at least in part, on the patient size; and
programming an x-ray device with the retrieved dosage.

31. The method of claim 30, where the x-ray dose comprises one or more of mA and kV.

32. The method of claim 30, where the patient size is one or more of a patient height, width, area, and volume.

33. A computer readable medium storing computer executable instructions operable to perform computer executable elements of the method of claim 30.

34. A system for controlling x-ray dose based on patient size, comprising:
means for determining a patient size;
means for calculating an x-ray dose parameter based on the patient size; and
means for programming an x-ray device with the calculated x-ray dose parameter.
